(19) United States
(12) Patent Application Publication
(10) Pub. No.: US 2005/0095393 A1
(43) Pub. Date: May 5, 2005

(54) Multi-layered towel and method for making the same

(76) Inventor: Bridgette Tabor-Cooper, Mitchelleville, MD (US)

Correspondence Address: Bridgette Tabor-Cooper, 12309 Woodwalk Terrace, Mitchelleville, MD, 20721, US

(21) Appl. No.: 10/698,418

(22) Filed: Nov. 3, 2003

(51) Int. Cl. B32B 3/06

(52) U.S. Cl. 428/99; 428/131

(57) ABSTRACT

A multi-layered towel for a hair salon is provided with an upper layer, which is water absorbent, and a lower layer, which is at least water-resistant. A method is also provided for making a multi-layered towel for a hair salon.

### BACKGROUND OF THE INVENTION

1. Field of the Invention

The present invention relates to hair salon equipment. In particular, the present invention relates to a multi-layered towel for a hair salon and a method of making the same.

2. Description of Related Art

Hair salons perform a variety of services for patrons that require treating the hair with various solutions and removing those solutions by repeated washing and rinsing of the hair. While these services are being performed, it is not unusual for a patron's clothing to get wet. This leaves the patron uncomfortable during the service and may leave his or her clothing wet, wrinkled, and spotted with solutions after the service is performed.

In an effort to eliminate a patron's discomfort and to reduce the chances that his or her clothing will become wet, wrinkled and spotted with solutions, hair salon service providers often use water absorbent towels, which are draped around the neck of a patron in an ad-hoc manner. Unfortunately, these water absorbent towels will provide protection for only so long, as the solutions or water will eventually leak through. Thus, the hair salon service provider must repeatedly replace the water absorbent towel in an effort to keep the patron dry. This practice both disrupts and prolongs the service, making the service less efficient and less profitable for the hair salon service provider.

Alternatively, a hair salon service provider may utilize a plastic sheet to keep a patron dry by wrapping it around the patron's neck while a service is being rendered. Unfortunately, the solutions or water simply flows down the side of the plastic sheet, which leaves clothing that covers the lower portions of a patron's torso wet, wrinkled and spotted with solutions.

### SUMMARY OF THE INVENTION

The principal advantage of the present invention is the provision of a multi-layered towel for a hair salon, which absorbs excess solutions and water, while at the same time keeping a patron dry and comfortable.

According to a first embodiment of the invention, a multi-layered towel is provided that includes an upper layer, which is water absorbent, and a lower layer, which is at least water resistant. The upper layer has a first opening and the lower layer has a second opening. The upper and lower layers are attached to each other such that the first opening overlaps the second opening to define a first overlapping area. Advantageously, the lower layer may be waterproof.

According to a first aspect of the first embodiment, the first overlapping area is large enough to accommodate a head of a person. In addition, the multi-layered towel is large enough to cover at least an upper torso of the person. The lower layer faces the upper torso of the person and the upper layer faces away from the upper torso of the person.

According to a second aspect of the first embodiment, the upper layer and the lower layer are attached to each other with thread.

According to a third aspect of the first embodiment, the upper layer and the lower layer are attached to each other using at least a section of Velcro, which is attached to one of the upper and lower layers, and which is disposed between the upper and lower layers.

According to a fourth aspect of the first embodiment, the multi-layered towel also includes a flap extending from an edge of the lower layer that is defined by at least a portion of the second opening.

According to a fifth aspect of the first embodiment, the upper layer has a first front portion and a first back portion. The first front portion has a first set of two opposing flaps including a first flap having a first inner portion and a second flap having a second inner portion. The first and second inner portions define the first opening. The lower layer has a second front portion and a second back portion, the second front portion having a second set of two opposing flaps including a third flap having a third inner portion and a fourth flap having a fourth inner portion. The third and fourth inner portions define the second opening. The first flap and third flap are on one side of the overlapping area, and the second flap and the fourth flap are on another side of the overlapping area.

With respect to the fifth aspect of the first embodiment, the multi-layered towel may include a fifth flap extending from the third and fourth inner portions of the lower layer.

Also with respect to the fifth aspect of the first embodiment, at least one of the first and third flaps may be made attachable to at least one of the second and fourth flaps.

Also with respect to the fifth aspect of the first embodiment, an attaching device may be provided, wherein at least one of the first and third flaps and at least one of the second and fourth flaps are made attachable to each other via the attaching device. The attaching device may include a first section of Velcro disposed on one of the first and third flaps and a second section of Velcro disposed on one of the second and fourth flaps. In this regard, the one of the first and third flaps and the one of the second and fourth flaps may be made attachable to each other by the first and second sections of Velcro. The attaching device may also include a pin.

Also with respect to the fifth aspect of the first embodiment, the first, second, third and fourth inner portions may each have a curved portion.

According to a second embodiment of the invention, a multi-layered towel is provided which is similar to the first embodiment in that it has an upper layer, which is water absorbent and a lower layer, which is at least waterproof. However, in accordance with the second embodiment, the first and second openings provided in the upper and lower layers, respectively, each include a circular portion. In addition, the first overlapping area is large enough to accommodate a head of a person.

According to a first aspect of the second embodiment, the multi-layered towel may also include a flap extending from an edge of the lower layer that is defined by at least a portion of the second opening.

According to a second aspect of the first embodiment, the multi-layered towel is large enough to cover at least an upper torso of the person. The lower layer faces the upper torso of the person and the upper layer faces away from the upper torso of the person.

The upper layer of the first and second embodiments may be made from cotton. In addition, the lower layer of the first and second embodiments may be made of coated nylon. The lower layer of the first and second embodiments may also be made of polyester.

According to a third embodiment of the invention, a method is provided for making a multi-layered towel for a hair salon. The method includes the steps of providing an upper layer, which is water absorbent, and making a first opening in the upper layer. The method also includes the steps of providing a lower layer, which is at least water resistant, and making a second opening in the lower layer. The method further includes the step of attaching the upper layer to the lower layer such that the first opening overlaps the second opening to define a first overlapping area.

According to a first aspect of the third embodiment, the first overlapping area is made large enough to accommodate a head of a person. In addition, the multi-layered towel is made large enough to cover at least an upper torso of the person. The lower layer is made to face the upper torso of the person and the upper layer is made to face away from the upper torso of the person.

According to a second aspect of the third embodiment, the method may also include the step of providing a flap that extends from an edge of the lower layer that is defined by at least a portion of the second opening.

According to a fourth embodiment of the present invention, a method is provided for making a multi-layered towel for a hair salon. The method includes the step of providing an upper layer, which is water absorbent, the upper layer having a first front portion and a first back portion. The method also includes the step of making a first set of two opposing flaps in the first front portion, the first set of opposing flaps including a first flap having a first inner portion and a second flap having a second inner portion, the first and second inner portions defining a first opening in the upper layer. The method also includes the step of providing a lower layer, which is at least water resistant, the lower layer having a second front portion and a second back portion. The method also includes the step of making a second set of two opposing flaps in the second front portion, the second set of opposing flaps including a third flap having a third inner portion and a fourth flap having a fourth inner portion, the third and fourth inner portions defining a second opening in the upper layer. The method also includes the step of attaching the upper layer to the lower layer such that the first opening overlaps the second opening to define a first overlapping area, the first and third flaps being placed on one side of the overlapping area and the second and fourth flaps being placed on another side of the overlapping area.

According to a first aspect of the fourth embodiment, the method may also include the step of providing a fifth flap extending from the third and fourth portions of the lower layer.

According to a fifth embodiment of the invention, a multi-layered towel is provided that includes an upper layer, which is water absorbent, and a lower layer, which is at least water resistant. The upper layer has a first edge that is curved inward such that it is contoured to the outline of a person's neck. The lower layer has a second edge that is curved inward such that is contoured to the outline of the person's neck. The second edge of the lower layer extends beyond the first edge of the upper layer to create a first flap that can be tucked under the neckline of the person's garment. Advantageously, the lower layer may be made of a waterproof material, such as coated nylon.

According to a first aspect of the fifth embodiment, the upper layer may further include a second flap defined by the first edge of the upper layer, which is made to abut the person's neck.

According to a second aspect of the fifth embodiment, the upper layer and the lower layer are attached to each other with thread.

According to a third aspect of the fifth embodiment, at least a portion of the upper layer and the lower layer are attached to each other with thread that is sewn in a curved line that is contoured to the outline of the person's neck.

According to a sixth embodiment of the invention, a method is provided for making a multi-layered towel for a hair salon. The method includes the step of providing an upper layer, which is water absorbent. The upper layer has a first edge that is curved inward such that it is contoured to the outline of a person's neck. The method also includes the step of providing a lower layer, which is at least water resistant. The lower layer has a second edge that is curved inward such that is contoured to the outline of the person's neck. The method also includes the step of attaching the upper layer to the lower layer such that the second edge of the lower layer extends beyond the first edge of the upper layer to create a first flap that can be tucked under the neckline of the person's garment.

According to an aspect of the sixth embodiment, the method further includes the step of providing the upper layer with a second flap defined by the first edge of the upper layer, the second flap being implemented to abut the person's neck.

According to another aspect of the sixth embodiment, the step of attaching includes the step of attaching at least a portion of the upper layer and the lower layer to each other with thread that is sewn in a curved line that is contoured to the outline of the person's neck.

It is to be understood that both the foregoing general description and the following detailed description are exemplary and explanatory and are intended to provide further explanation of the invention as claimed.

### BRIEF DESCRIPTION OF THE DRAWINGS

These and other features, aspects and advantages of the present invention will become better understood with reference to the following description, appended claims, and accompanying drawings, in which:

FIG. 1 depicts a multi-layered towel in accordance with the first embodiment of the present invention.

FIG. 2 depicts an upper layer of a multi-layered towel in accordance with the first embodiment of the present invention.

FIG. 3 depicts a lower layer of a multi-layered towel in accordance with the first embodiment of the present invention.

FIG. 4 depicts a lower layer of a multi-layered towel in accordance with one aspect of the first embodiment of the present invention.

FIG. 5 depicts another multi-layered towel in accordance with a second embodiment of the present invention.

FIG. 6 depicts an upper layer of a multi-layered towel in accordance with the second embodiment of the present invention.

FIG. 7 depicts a lower layer of a multi-layered towel in accordance with the second embodiment of the present invention.

FIG. 8 depicts a lower layer of a multi-layered towel in accordance with one aspect of the second embodiment of the present invention.

FIG. 9 is a flow chart depicting the steps of a method in accordance with a third embodiment of the present invention.

FIG. 10 is a flow chart depicting the steps of a method in accordance with a fourth embodiment of the present invention.

FIG. 11 depicts a multi-layered towel in accordance with the first embodiment of the present invention.

FIG. 12 depicts an upper layer of a multi-layered towel in accordance with the first embodiment of the present invention.

FIG. 13 depicts a lower layer of a multi-layered towel in accordance with the first embodiment of the present invention.

FIG. 14 is a flow chart depicting the steps of a method in accordance with a third embodiment of the present invention.

### DETAILED DESCRIPTION OF THE PREFERRED EMBODIMENTS

The present invention is directed to a multi-layered towel for a hair salon and a method of making the same. Advantageously, the multi-layered towel absorbs excess solutions and water, while at the same time keeping a patron dry and comfortable.

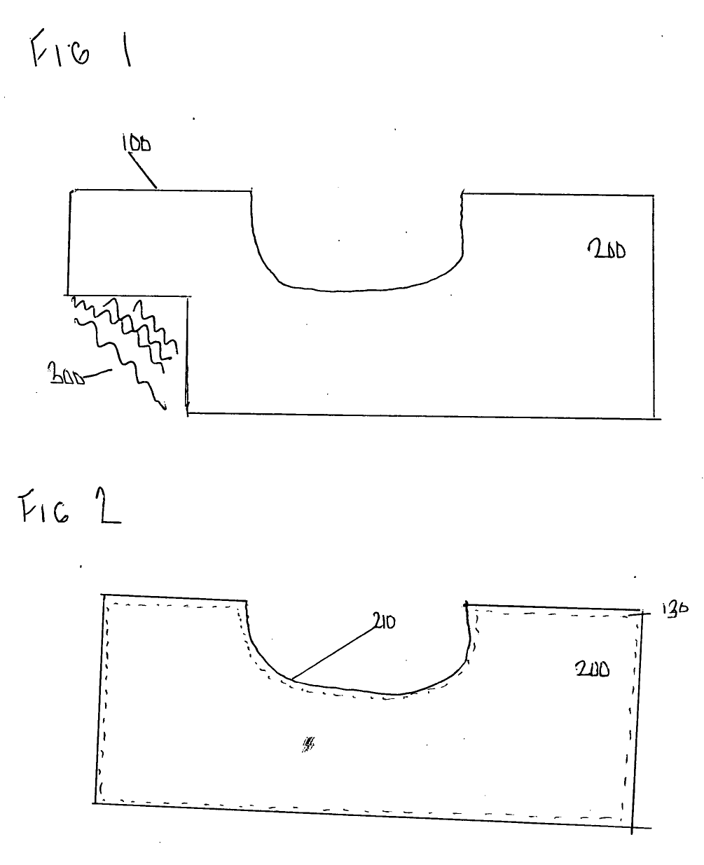

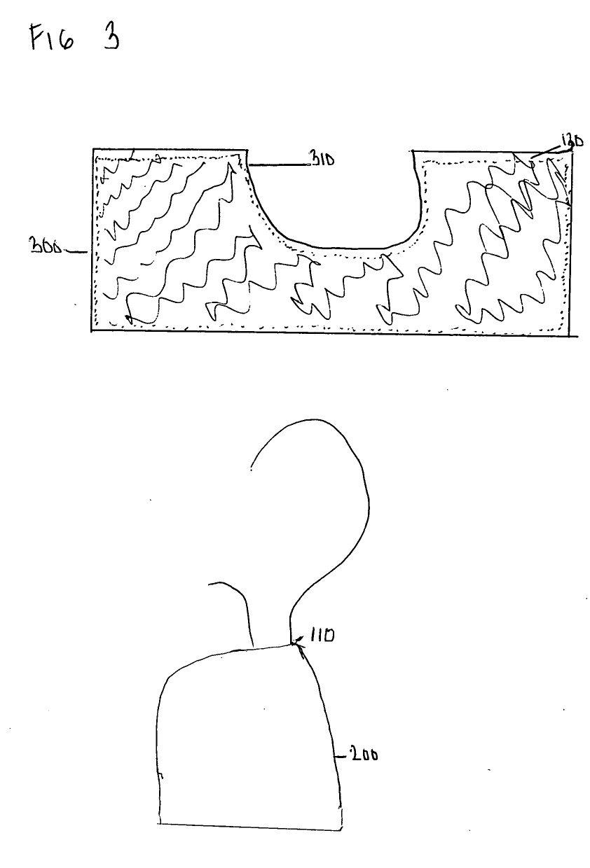

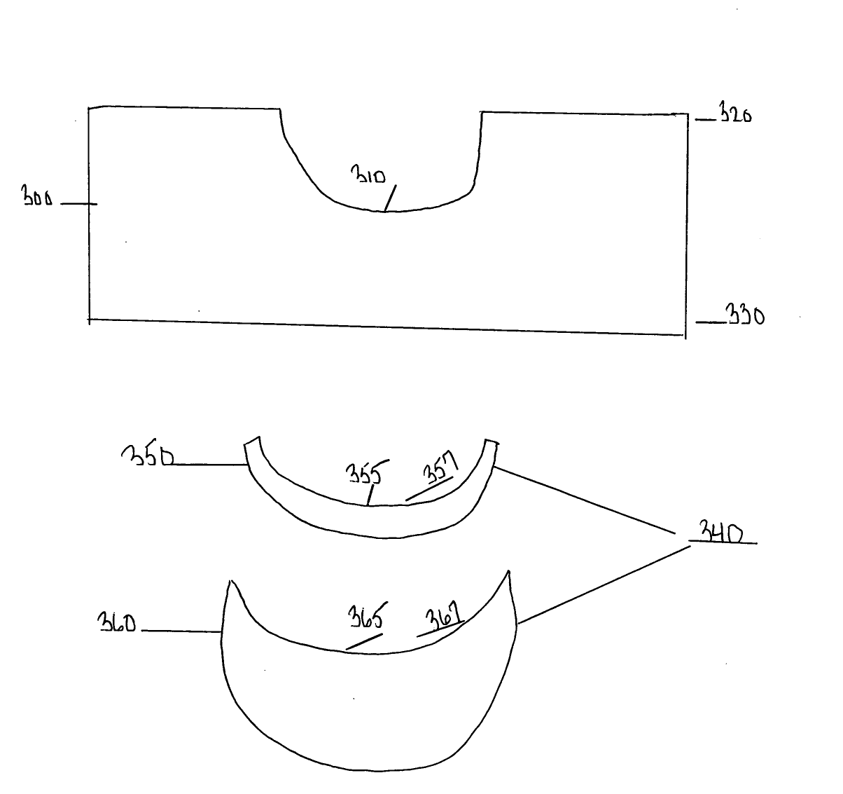

FIGS. 1-3 depict a multi-layered towel 100 in accordance with a first embodiment of the present invention. The multi-layered towel 100 includes an upper layer 200 (shown in FIGS. 1 and 2), which is water absorbent, and a lower layer 300 (shown in FIGS. 1 and 3), which is at least water resistant. The upper layer 200 has a first opening 210 and the lower layer 300 has a second opening 310. The upper and lower layers 200 and 300 are attached to each other such that the first opening 210 overlaps the second opening 310 to define a first overlapping area 110, which should be large enough to accommodate a head 120 of a person (not numbered). Advantageously, the lower layer 300 may be water resistant, water repellant, or waterproof. With regard to use of water resistant or water repellant materials, the lower layer 300 may be made of, for example, microfiber. With regard to the use of a waterproof material, the lower layer 300 may be made of, for example, a coated nylon (e.g., 100% coated nylon, or polyurethane coated nylon), which may be washed and dried repeatedly without any shrinking. In addition, the multi-layered towel 100 should be large enough to cover at least a portion of an upper torso (not shown) of the person. The lower layer 300 faces the upper torso of the person and the upper layer 200 faces away from the upper torso of the person.

Those skilled in the art will appreciate that the upper layer 200 and the lower layer 300 may be attached to each in a variety of ways. By way of example, the upper and lower layers 200 and 300 may be attached or sewn to each other with thread 130. As another example, the upper and lower layers 200 and 300 may be attached to each other using at least a section of Velcro (not shown), which is attached to at least the lower layer 200, and which is disposed between the upper and lower layers 200 and 300. The section of Velcro may be made to attach to the upper layer 300 if, for example, the upper layer 300 is made out of terry cloth. Alternatively, an additional section of Velcro (not shown) may be attached to the upper layer 300 and also disposed between the upper and lower layers 200 and 300. In this way, instead of having one section of Velcro being attached to an upper layer made of, for example, terry cloth, the two sections of Velcro may be attachable to each other to better ensure that the upper and lower layers 200 and 300 remain connected.

The upper layer 200 has a first front portion 220 and a first back portion 230. The first front portion 220 has a first set of two opposing flaps 240 including a first flap 250 having a first inner portion 255 and a second flap 260 having a second inner portion 265. The first and second inner portions 255 and 265 define the first opening 210. The lower layer 300 has a second front portion 320 and a second back portion 330, the second front portion 320 having a second set of two opposing flaps 340 including a third flap 350 having a third inner portion 355 and a fourth flap 360 having a fourth inner portion 365. The third and fourth inner portions 355 and 365 define the second opening 310. The first flap 250 and third flap 350 are on one side of the overlapping area 310, and the second flap 260 and the fourth flap 360 are on another side of the overlapping area 310. As an option, the first, second, third and fourth inner portions 255, 265, 355 and 365 have corresponding curved portions 257, 267, 357 and 367. The curved portions 257, 267, 357 and 367 create a greater overlap between opposing flaps to better ensure that a patron's clothing will not be exposed to additional volumes of solutions or water.

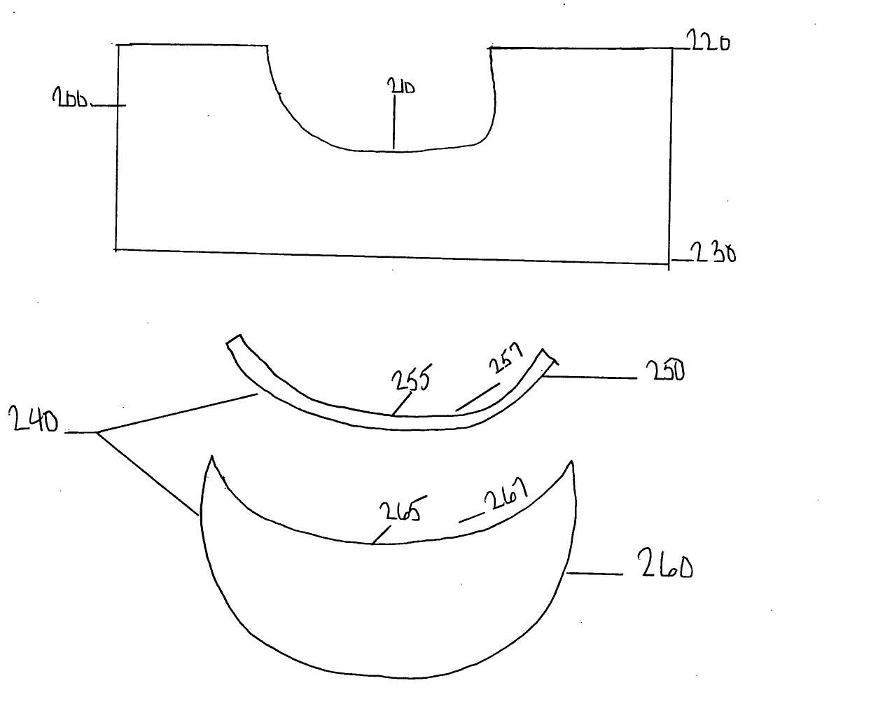

As shown in FIG. 4, the multi-layered towel of the present invention may also include a flap 400 extending from the third and fourth inner portions 355 and 365 of the lower layer 300. The flap 400 may be placed over the collar (not shown) of, for example, a shirt worn by the person (not shown) being serviced, as an added means of protecting the person's clothing from becoming wet or spotted with solutions applied by the hair salon service provider. The flap 400 may be made of a water resistant, water repellant or waterproof material. As noted above, with regard to the use of water resistant or water repellant materials, the flap 400 may be made of, for example, microfiber. With regard to the use of a waterproof material, the flap 400 may be made of, for example, a coated nylon (e.g., 100% coated nylon, or polyurethane coated nylon), which may be washed and dried repeatedly without any shrinking.

Advantageously, at least one of the first and third flaps 250 and 350 may be made attachable to at least one of the second and fourth flaps 260 and 360. To facilitate such an attachment, an attaching device 370 may be provided, wherein at least one of the first and third flaps 250 and 350 and at least one of the second and fourth flaps 260 and 360 are made attachable to each other via the attaching device 370.

The attaching device 370 may include a first section of Velcro 375 is disposed on the upper side of the first flap 250 and a second section of Velcro 380 is disposed on the lower side of the fourth flap 360. In this way, the first and fourth flaps 250 and 360 are made attachable to each other by the first and second sections of Velcro 375 and 380, respectively.

Alternatively, the first section of Velcro 375 may be disposed on the lower side of the second flap 260 and the second section of Velcro 380 may be disposed on the upper side of the third flap 350. In this way, the second and third flaps 260 and 350 are made attachable to each other by the first and second sections of Velcro 375 and 380, respectively.

As an alternative to the use of Velcro, the attaching device 370 may include a pin (not shown), which can be used to attach at least the first and fourth flaps 250 and 360, or the second and third flaps 260 and 350, respectively. The pin may also be used to hold in place the first, second, third and fourth flaps 250, 260, 350 and 360. One of ordinary skill in the art will recognize that other attaching devices may be employed to keep the flaps 250, 260, 350 and 360 held in place.

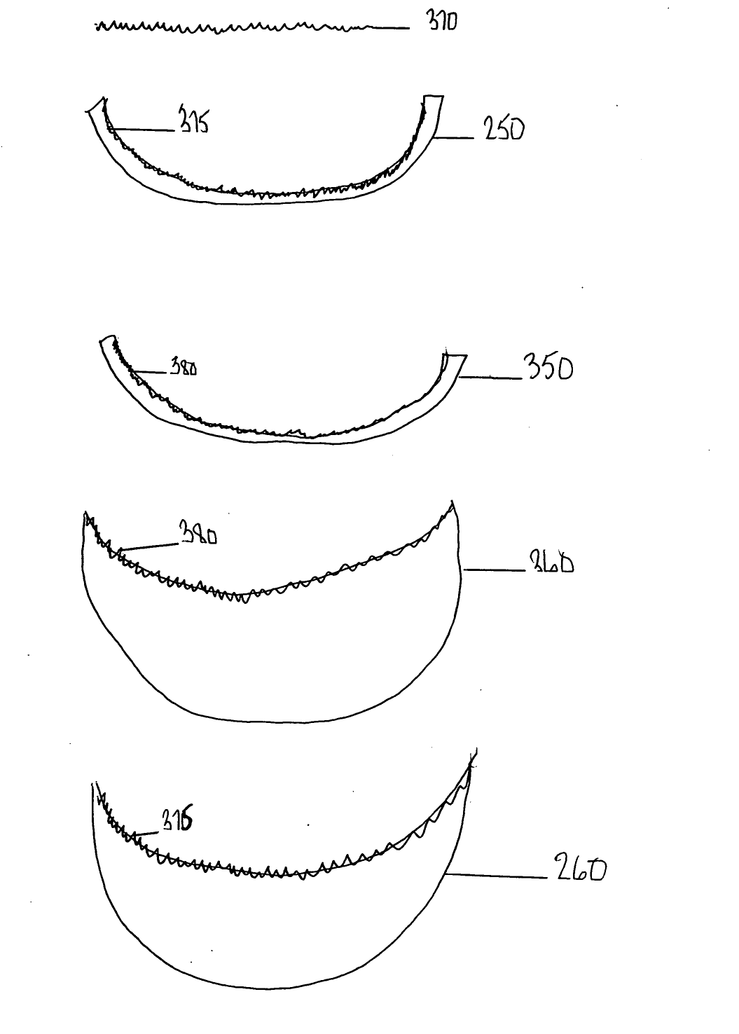

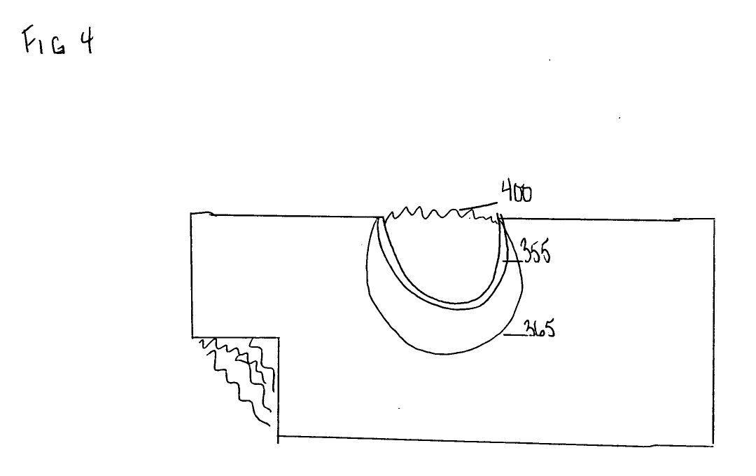

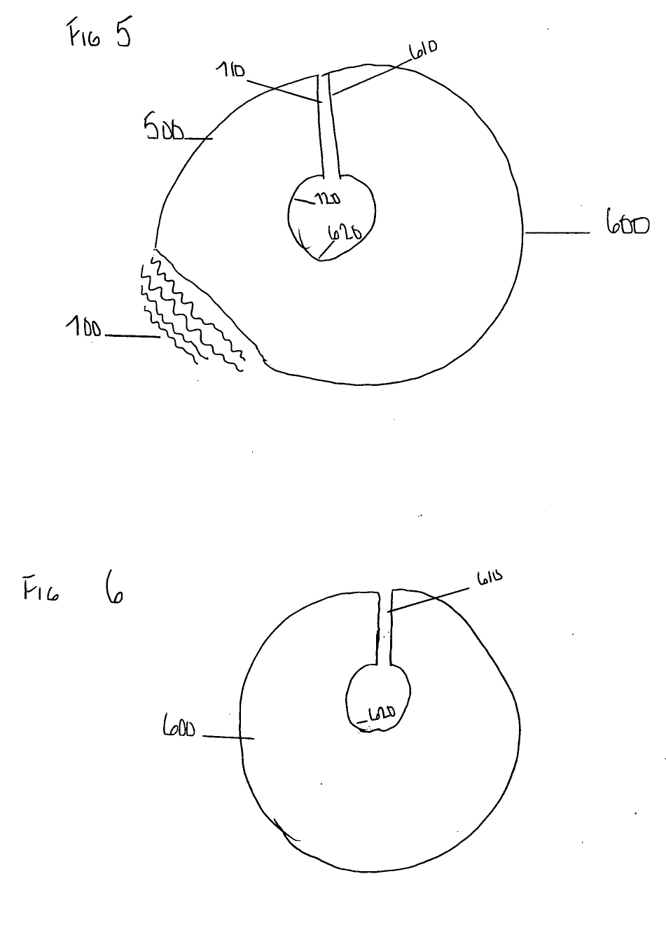

FIGS. 5-7 depict a multi-layered towel 500 in accordance with a second embodiment of the present invention. The multi-layered towel 500 includes an upper layer 600 (shown in FIGS. 5 and 6), which is water absorbent, and a lower layer 700 (shown in FIGS. 5 and 7), which is at least water resistant. The upper layer 600 has a first opening 610 including a first circular portion 620 and the lower layer 700 has a second opening 710 including a second circular portion 720. The upper and lower layers 600 and 700 are attached to each other such that the first opening 610 overlaps the second opening 710 to define a first overlapping area 510, which should be large enough to accommodate a head 520 of a person (not numbered). Advantageously, the lower layer 700 may be water repellant or waterproof. In addition, the multi-layered towel 500 should be large enough to cover at least an upper torso (not shown) of the person. The lower layer 700 faces the upper torso of the person and the upper layer 600 faces away from the upper torso of the person.

Those skilled in the art will understand that the upper layer 600 and the lower layer 700 may be attached to each in a variety of ways. By way of example, the upper and lower layers 600 and 700 may be attached or sewn to each other with thread 530. As another example, the upper and lower layers 600 and 700 may be attached to each other using at least a section of Velcro (not shown), which is attached to at least the lower layer 600, and which is disposed between the upper and lower layers 600 and 700. The section of Velcro may be made to attach to the upper layer 700 if, for example, the upper layer 700 is made out of terry cloth. Alternatively, an additional section of Velcro (not shown) may be attached to the upper layer 700 and also disposed between the upper and lower layers 600 and 700. In this way, instead of having one section of Velcro being attached to an upper layer made of, for example, terry cloth, the two sections of Velcro may be attachable to each other to better ensure that the upper and lower layers 600 and 700 remain connected.

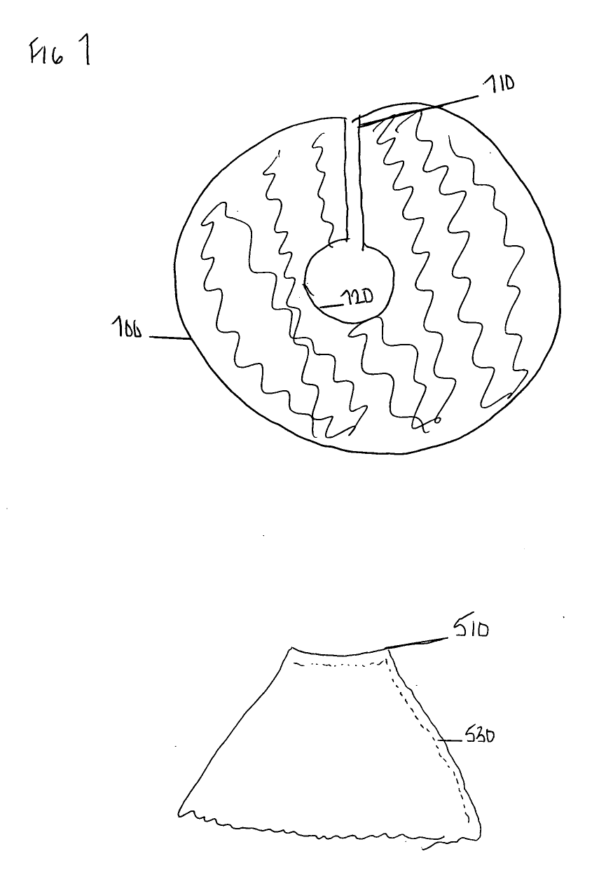

As shown in FIG. 8, the multi-layered towel of the present invention may also include a flap 800 extending from an edge of the lower layer 700 that is defined by at least a portion of the second opening 710. The flap 800 may be placed over the collar (not shown) of, for example, a shirt worn by the person (not shown) being serviced, as an added means of protecting the person's clothing from becoming wet or spotted with solutions applied by the hair salon service provider. As an alternative to the use of the flap 800, a strip of water absorbent material (not shown) may be attached an edge of the lower layer 700 that is defined by at least a portion of the second opening 710 to further protect a person's clothing.

With respect to the multi-layered towels of the first and second embodiments described above, the upper layer may be made from cotton or any other water absorbent material. The upper layer should be pre-shrunk so that it lays flat even after numerous washings. Preferably, the upper layer is made from a pre-shrunk terry cloth. Also with respect to the multi-layered towels of the first and second embodiments, the lower layer may be made of coated nylon, polyurethane coated nylon or any other material, which is at least water resistant. The lower layer may be made of a combination polyurethane and polyester. The combination of polyurethane and polyester may be advantageously made from fibers woven tightly together (e.g., microfiber). One of ordinary skill in the art would appreciate that other water absorbent materials may be employed for the upper layer and that other water resistant, water repellant, or waterproof materials may be employed for the lower layer, as noted above.

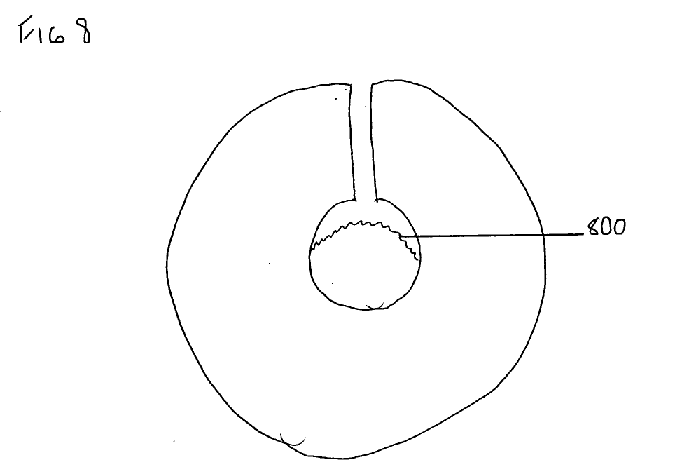

FIG. 9 is a flow chart depicting the steps of method for making a multi-layered towel for a hair salon in accordance with a third embodiment of the present invention. The method includes the steps of providing 900 an upper layer, which is water absorbent, and making 910 a first opening in the upper layer. The method also includes the steps of providing 920 a lower layer, which is at least water resistant, and making 930 a second opening in the lower layer. The method further includes the step of attaching 940 the upper layer to the lower layer such that the first opening overlaps the second opening to define a first overlapping area. The first overlapping area should be made large enough to accommodate a head of a person. In addition, the multi-layered towel should be made large enough to cover at least an upper torso of the person. The lower layer is made to face the upper torso of the person and the upper layer is made to face away from the upper torso of the person.

As an option, the method may also include the step of providing 950 a flap that extends from an edge of the lower layer that is defined by at least a portion of the second opening. As an alternative to the step 950, the method may include the step of attaching a strip of water absorbent material to an edge of the lower layer that is defined by at least a portion of the second opening.

The upper and lower layers of the multi-layered towel made in accordance with the method described in connection with the third embodiment of the present invention may be made of the same materials described above in connection with the multi-layered towels of the first and second embodiments.

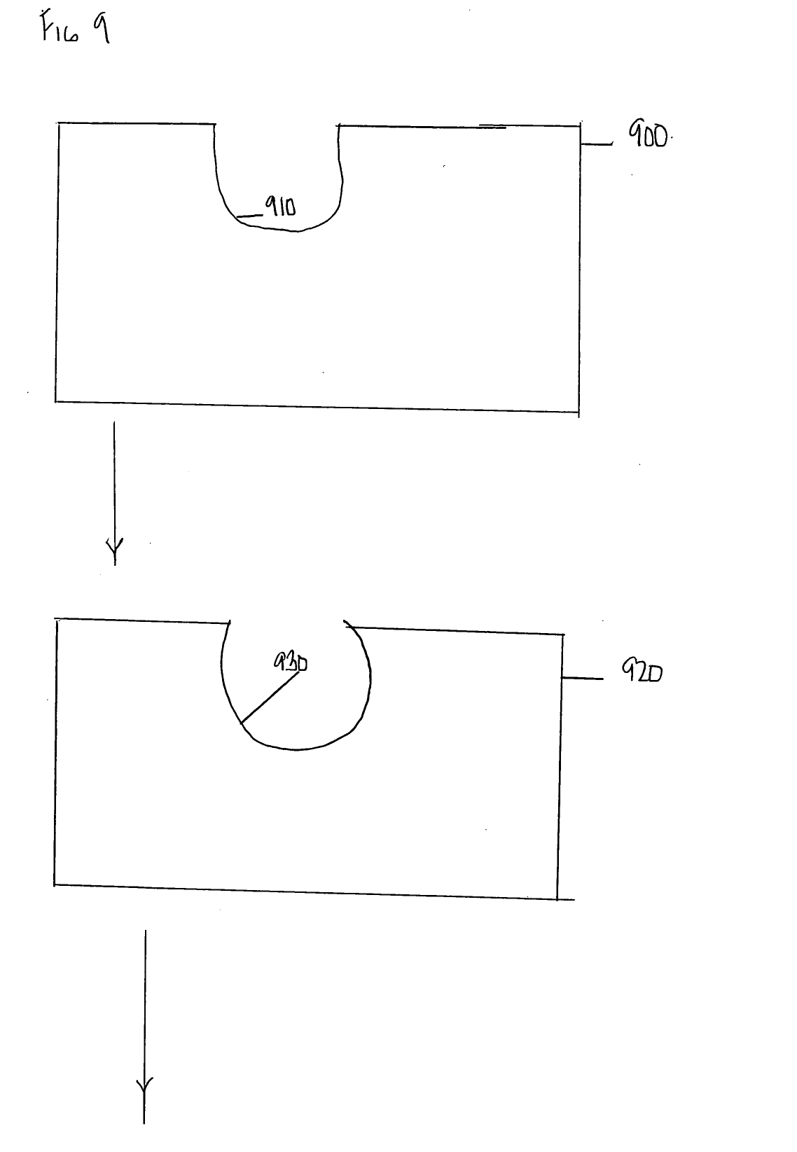

FIG. 10 is a flow chart depicting the steps of method for making a multi-layered towel for a hair salon in accordance with a fourth embodiment of the present invention. The method includes the step of providing 1000 an upper layer, which is water absorbent, the upper layer having a first front portion and a first back portion. The method also includes the step of making 1005 a first set of two opposing flaps in the first front portion, the first set of opposing flaps including a first flap having a first inner portion and a second flap having a second inner portion, the first and second inner portions defining a first opening in the upper layer.

The method also includes the step of providing 1010 a lower layer, which is at least water resistant, the lower layer having a second front portion and a second back portion. The method also includes the step of making 1015 a second set of two opposing flaps in the second front portion, the second set of opposing flaps including a third flap having a third inner portion and a fourth flap having a fourth inner portion, the third and fourth inner portions defining a second opening in the upper layer. The method also includes the step of attaching 1020 the upper layer to the lower layer such that the first opening overlaps the second opening to define a first overlapping area, the first and third flaps being placed on one side of the overlapping area and the second and fourth flaps being placed on another side of the overlapping area. As an option, the method may also include the step of providing 1025 a fifth flap extending from the third and fourth portions of the lower layer. As an alternative to the option including step 1025, the method may include the step of attaching a strip of water absorbent material to the third and fourth portions of the lower layer.

The upper and lower layers of the multi-layered towel made in accordance with the method described in connection with the fourth embodiment of the present invention may be made of the same materials described above in connection with the multi-layered towels of the first and second embodiments.

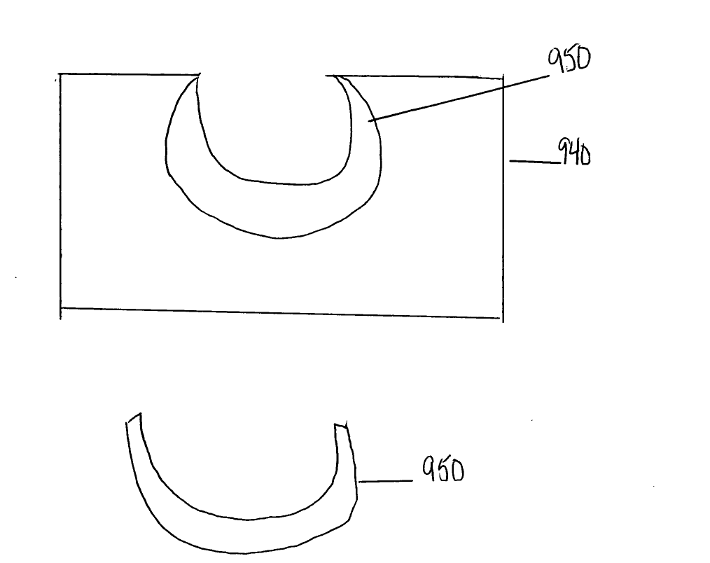

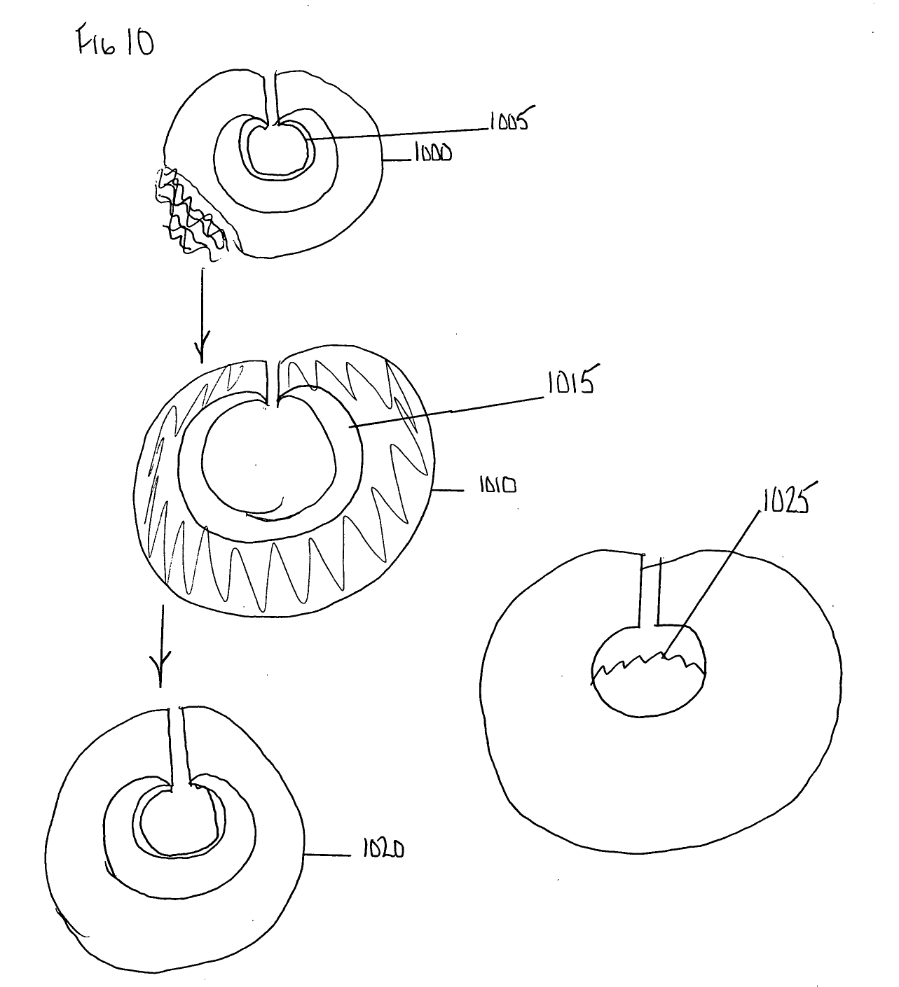

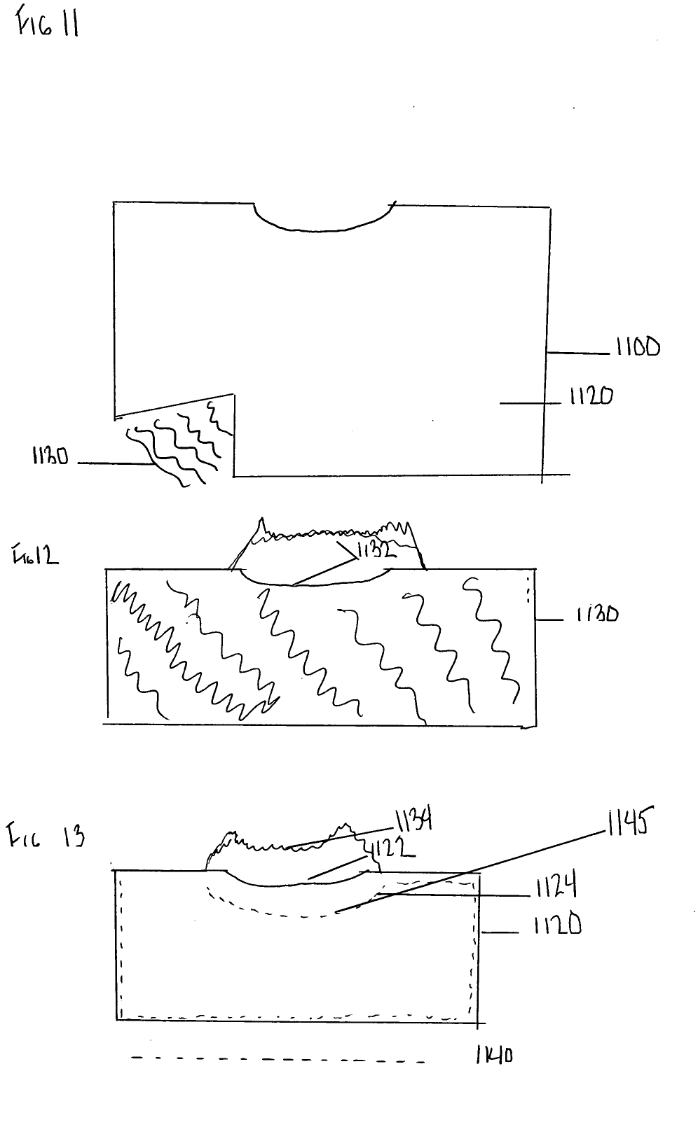

FIGS. 11-13 depict a multi-layered towel 1100 in accordance with a fifth embodiment of the present invention, which is considered the best mode of carrying out the invention. It is particularly suited for low-cost manufacturing because it can be made efficiently with only a limited number of pieces. The multi-layered towel 1100 includes an upper layer 1120 (shown in FIGS. 11 and 12), which is water absorbent, and a lower layer 1130 (shown in FIGS. 11 and 13), which is at least water resistant. The upper layer 1120 has a first edge 1122 that is curved inward such that it is contoured to the outline of a person's neck. The lower layer 1130 has a second edge 1132 that is curved inward such that is contoured to the outline of the person's neck. The second edge 1132 of the lower layer 1130 extends beyond the first edge 1122 of the upper layer 1120 to create a first flap 1134 that can be tucked under the neckline of the person's garment. The upper layer 1120 may also include a second flap 1124 that is defined by the first edge 1122 of the upper layer 1120. The second flap 1124 is meant to abut a person's neck to keep liquid from wetting either the person or his or her garments.

Those skilled in the art will appreciate that the upper layer 1120 and the lower layer 1130 may be attached to each in a variety of ways. By way of example, the upper and lower layers 1120 and 1130 may be attached or sewn to each other with thread 1140. Preferably, the upper and lower layers 1120 and 1130 may be attached or sewn to each other with thread 1140 that is at least sewn in a curved line 1145 (shown as a dashed line) that is contoured to the outline of the person's neck.

Advantageously, the lower layer 1130 may be water resistant, water repellant, or waterproof. With regard to use of water resistant or water repellant materials, the lower layer 1130 may be made of, for example, microfiber. With regard to the use of a waterproof material, the lower layer 1130 may be made of, for example, a coated nylon (e.g., 100% coated nylon, or polyurethane coated nylon), which may be washed and dried repeatedly without any shrinking. In addition, the multi-layered towel 1100 should be large enough to cover at least a portion of an upper torso (not shown) of the person. The lower layer 1130 faces the upper torso of the person and the upper layer 1120 faces away from the upper torso of the person.

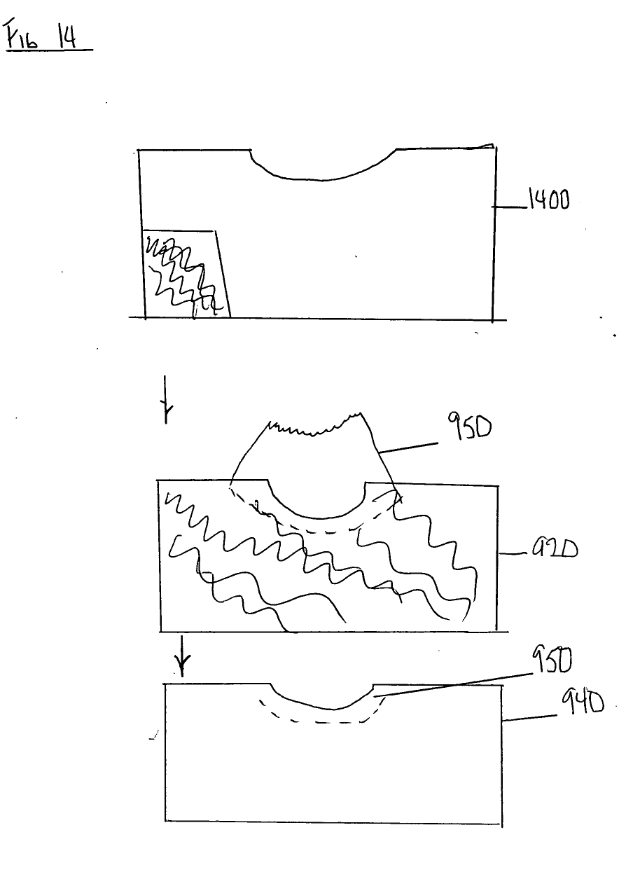

FIG. 14 is a flow chart depicting the steps of method for making a multi-layered towel for a hair salon in accordance with a sixth embodiment of the present invention. The method includes the steps of providing 1400 an upper layer, which is water absorbent. The upper layer has a first edge that is curved inward such that it is contoured to the outline of a person's neck. The method also includes the steps of providing 920 a lower layer, which is at least water resistant. The lower layer has a second edge that is curved inward such that is contoured to the outline of the person's neck.

The method further includes the step of attaching 940 the upper layer to the lower layer such that the second edge of the lower layer extends beyond the first edge of the upper layer to create a first flap that can be tucked under the neckline of the person's garment.

In addition, the multi-layered towel may be made large enough to cover at least an upper torso of the person. The lower layer is made to face the upper torso of the person and the upper layer is made to face away from the upper torso of the person.

As an option, the method may also include the step of providing 950 the upper layer with a second flap defined by the first edge of the upper layer, the second flap being implemented to abut the person's neck.

Those skilled in the art will appreciate that the upper layer and the lower layer may be attached to each in a variety of ways. By way of example, the upper and lower layers may be attached or sewn to each other with thread. Preferably, the upper and lower layers may be attached or sewn to each other with thread that is at least sewn in a curved line that is contoured to the outline of the person's neck.

The upper and lower layers of the multi-layered towel made in accordance with the method described in connection with the sixth embodiment of the present invention may be made of the same materials described above in connection with the multi-layered towels of the first, second and fifth embodiments.

Although the present invention has been described in detail with reference to certain preferred embodiments, thereof, other embodiments are possible. For example, additional layers may be placed between the upper and lower layers of the multi-layered towel. At least one of these layers may be heat-resistant, such that when the hair salon patron is put under a dryer, for example, the lower layer, which is at least water resistant, will not be over heated or even melted by the heat emanating from the dryer. Additional water absorbent layers may also be provided to soak up additional volumes of solutions or water resulting from the service being provided to, for example, the hair salon patron. Therefore, the spirit and scope of the appended claims should not be limited to the description of the preferred embodiments contained herein.

1. A multi-layered towel comprising:
an upper layer, which is water absorbent; and
a lower layer, which is at least water resistant;
wherein said upper layer has a first opening and said lower layer has a second opening, said upper and lower layers being attached to each other such that the first opening overlaps the second opening to define a first overlapping area.

2. The multi-layered towel defined in claim 1, wherein said lower layer is waterproof.

3. The multi-layered towel defined in claim 1, wherein the first overlapping area is large enough to accommodate a head of a person.

4. The multi-layered towel defined in claim 3, wherein said multi-layered towel is large enough to cover at least an upper torso of the person, said lower layer facing the upper torso of the person, said upper layer facing away from the upper torso of the person.

5. The multi-layered towel defined in claim 1, further comprising a flap extending from an edge of said lower layer that is defined by at least a portion of the second opening.

6. The multi-layered towel defined in claim 1, wherein said upper layer and said lower layer are attached to each other with thread.

7. The multi-layered towel defined in claim 1, wherein said upper layer and said lower layer are attached to each other using at least a section of Velcro, which is attached to one of said upper and lower layers, and which is disposed between said upper and lower layers.

8. The multi-layered towel defined in claim 1, wherein said upper layer has a first front portion and a first back portion, the first front portion having a first set of two opposing flaps including a first flap having a first inner portion and a second flap having a second inner portion, the first and second inner portions defining the first opening;
wherein said lower layer has a second front portion and a second back portion, the second front portion having a second set of two opposing flaps including a third flap having a third inner portion and a fourth flap having a fourth inner portion, the third and fourth inner portions defining the second opening;
wherein the first flap and third flap are on one side of the overlapping area; and
wherein the second flap and the fourth flap are on another side of the overlapping area.

9. The multi-layered towel defined in claim 8, further comprising a fifth flap extending from said third and fourth inner portions of said lower layer.

10. The multi-layered towel defined in claim 8, wherein at least one of the first and third flaps is made attachable to at least one of the second and fourth flaps.

11. The multi-layered towel defined in claim 8, further comprising an attaching device, wherein at least one of the first and third flaps and at least one of the second and fourth flaps are made attachable to each other via said attaching device.

12. The multi-layered towel defined in claim 11, wherein said attaching device comprises a first section of Velcro disposed on one of the first and third flaps and a second section of Velcro disposed on one of the second and fourth flaps, wherein the one of the first and third flaps and the one of the second and fourth flaps are made attachable to each other by the first and second sections of Velcro.

13. The multi-layered towel defined in claim 11, wherein said attaching device comprises a pin.

14. The multi-layered towel defined in claim 8, wherein said first, second, third and fourth inner portions each have a curved portion.

15. The multi-layered towel defined in claim 1, wherein the first and second openings each include a circular portion, and the first overlapping area is large enough to accommodate a head of a person.

16. The multi-layered towel defined in claim 15, further comprising a flap extending from an edge of said lower layer that is defined by at least a portion of the second opening.

17. The multi-layered towel defined in claim 15, wherein said multi-layered towel is large enough to cover at least an upper torso of the person, said lower layer facing the upper torso of the person, said upper layer facing away from the upper torso of the person.

18. The multi-layered towel defined in claim 1, wherein said upper layer is made from cotton.

19. The multi-layered towel defined in claim 1, wherein said lower layer is made of polyurethane.

20. The multi-layered towel defined by claim 19, wherein said lower layer is also made of polyester.

21. A method of making a multi-layered towel for a hair salon, said method comprising the steps of:
providing an upper layer, which is water absorbent;
making a first opening in said upper layer;
providing a lower layer, which is at least water resistant;
making a second opening in said lower layer; and
attaching said upper layer to said lower layer such that the first opening overlaps the second opening to define a first overlapping area.

22. The method defined in claim 21, wherein the first overlapping area is made large enough to accommodate a head of a person.

23. The method defined in claim 22, wherein said multi-layered towel is made large enough to cover at least an upper torso of the person, said lower layer being made to face the upper torso of the person, the upper layer being made to face away from the upper torso of the person.

24. The method defined in claim 21, further comprising the step of providing a flap that extends from an edge of the lower layer that is defined by at least a portion of the second opening.

25. A method of making a multi-layered towel for a hair salon, said method comprising the steps of:
providing an upper layer, which is water absorbent, said upper layer having a first front portion and a first back portion;
making a first set of two opposing flaps in the first front portion, the first set of opposing flaps including a first flap having a first inner portion and a second flap having a second inner portion, the first and second inner portions defining a first opening in said upper layer;
providing a lower layer, which is at least water resistant, said lower layer having a second front portion and a second back portion;
making a second set of two opposing flaps in the second front portion, the second set of opposing flaps including a third flap having a third inner portion and a fourth flap having a fourth inner portion, the third and fourth inner portions defining a second opening in said upper layer; and
attaching said upper layer to said lower layer such that the first opening overlaps the second opening to define a first overlapping area, the first and third flaps being placed on one side of the overlapping area and the second and fourth flaps being placed on another side of the overlapping area.

26. The method defined in claim 25, further comprising the step of providing a fifth flap extending from said third and fourth portions of said lower layer.

27. A multi-layered towel comprising:
an upper layer, which is water absorbent; and
a lower layer, which is at least water resistant;
wherein said upper layer has a first edge that is curved inward such that it is contoured to the outline of a person's neck; and
wherein said lower layer has a second edge that is curved inward such that is contoured to the outline of the person's neck, the second edge of said lower layer extending beyond the first edge of the upper layer to create a first flap that can be tucked under the neckline of the person's garment.

28. The multi-layered towel defined in claim 27, wherein said lower layer is waterproof.

29. The multi-layered towel defined in claim 28, wherein said lower layer is made of coated nylon.

30. The multi-layered towel defined in claim 27, wherein said upper layer further comprises a second flap defined by the first edge of the upper layer, which is made to abut the person's neck.

31. The multi-layered towel defined in claim 27, wherein said upper layer and said lower layer are attached to each other with thread.

32. The multi-layered towel defined in claim 27, wherein at least a portion of said upper layer and said lower layer are attached to each other with thread that is sewn in a curved line that is contoured to the outline of the person's neck.

33. A method of making a multi-layered towel for a hair salon, said method comprising the steps of:
providing an upper layer, which is water absorbent, said upper layer having a first edge that is curved inward such that it is contoured to the outline of a person's neck;
providing a lower layer, which is at least water resistant, said lower layer having a second edge that is curved inward such that is contoured to the outline of the person's neck; and
attaching said upper layer to said lower layer such that the second edge of said lower layer extends beyond the first edge of the upper layer to create a first flap that can be tucked under the neckline of the person's garment.

34. The method defined by claim 33, further comprising the step of providing said upper layer with a second flap defined by the first edge of the upper layer, the second flap being implemented to abut the person's neck.

35. The method defined by claim 33, wherein the step of attaching comprises the step of attaching at least a portion of said upper layer and said lower layer to each other with thread that is sewn in a curved line that is contoured to the outline of the person's neck.
